(19) United States
(12) Patent Application Publication
(10) Pub. No.: US 2009/0214315 A1
(43) Pub. Date: Aug. 27, 2009

(54) Drop-in anchor for concrete structures

(75) Inventors: David L. Kelly, Sacramento, CA (US); Scott L. Collins, Roseville, CA (US)

Correspondence Address: DERGOSITS & NOAH LLP, Three Embarcadero Center, Suite 410, SAN FRANCISCO, CA, 94111, US

(73) Assignee: MMI Management Services LP

(21) Appl. No.: 12/070,946

(22) Filed: Feb. 22, 2008

(51) Int. Cl. F16B 13/04; F16B 13/06; B23P 19/04

(52) U.S. Cl. 411/33; 411/57.1; 29/700

(57) ABSTRACT

A radially expansible sleeve to provide part of a drop-in anchor for receipt in a bore formed in a concrete structure. The sleeve has arcuate protrusions with knife-like distal edges extending therearound. Upon radial expansion of the sleeve, the knife-like edges cut into the interior surface of the bore to anchor the sleeve in place.

The present invention relates to a drop-in anchor for use in a cylindrical bore formed in a concrete structure and, more particularly, is concerned with an expansible sleeve for such an anchor which is provided with protrusions having knife-like edges which cut into the walls of the bore to secure the anchor in place.

### BACKGROUND OF THE INVENTION

Various types of drop-in anchors have been provided in the prior art. Typically, these are used to secure some type of an object, such as the base for a tilt-up brace, to a concrete wall or floor. These anchors are generally temporary. Once they have served their purpose, the part or parts of the anchor which extend from the surface of the concrete structure are removed. The bore may then be grouted over, or otherwise closed.

Prior art anchors generally employ some type of an expansible sleeve which is inserted into a bore formed in the concrete structure, and then expanded to grip the wall of the bore. The sleeve serves as the part to which the bolt of the anchor may be secured.

U.S. Pat. No. 6,666,636 discloses a drop-in anchor of the above described type. This anchor has components corresponding generally to those of the present invention, except for the provision of knife like protrusions on the expansible sleeve. U.S. Pat. No. 5,116,176 is of interest in that it discloses an expansion anchor having a sleeve which may be inserted into a bore formed in a concrete structure, wherein the sleeve carries rings which are expansible into biting engagement with the bore. This patent also shows a prior art device wherein the angular grooves are formed around a sleeve like anchor.

Another example of a drop-in anchor is found in U.S. Pat. No. 4,690,597, wherein the anchor employs an expansible sleeve like element designed to engage an undercut formed in the bore of the member to which the anchor is secured.

### SUMMARY OF THE INVENTION

The present invention provides an apparatus and method employing a sleeve with knife-like arcuate protrusions extending therefrom for expansion into cutting engagement with the walls of a bore formed in the concrete member. The sleeve is co-axially insertable into the bore and has a diameter slightly less than that of the bore. Upon expansion of the sleeve within the bore, the protrusions cut into the bore and secure the sleeve in place.

A principal object of the invention is to provide a drop-in anchor for secure engagement within a bore formed in a concrete structure.

Another and more specific object of the invention is to provide such an anchor wherein knife-like protrusions forming part of the anchor are expanded into cutting engagement with the walls of the bore.

Yet another object of the invention is to provide such an anchor wherein the anchoring function is not reliant solely upon frictional forces.

A further object of the invention is to provide a drop-in anchor for use in a concrete structure which avoids frictional movement of the anchor relative to the structure and resultant fluidization of the concrete surface at the interface of the anchor and the concrete.

Still another object of the invention is to provide such an anchor wherein which does require the formation of an undercut in the bore of the concrete member within which the anchor is received.

The foregoing objects are not intended to be exhaustive of all of the benefits which flow from the present invention. Others will become apparent from the accompanying drawings and description of the preferred embodiment.

### BRIEF DESCRIPTION OF THE DRAWINGS

FIG. 1 is a cross-sectional elevational view of the anchor of the present invention, received within a bore formed in a concrete slab, as the anchor would appear after being set in place;

FIG. 2 is an elevational view of the anchor sleeve;

FIG. 3 is a bottom plan view of the anchor sleeve shown in FIG. 2;

FIG. 4 is an elevational view of the bolt of the anchor;

FIG. 5 is a top plan view of the bolt;

FIG. 6 is a perspective view, in cross-section, of a concrete slab having a bore formed therein for receipt of the anchor;

FIG. 7 is a perspective view, similar to FIG. 6, showing the anchor of the present invention, with the bolt in place, in the process of being driven into the bore in the concrete slab;

FIG. 8 is a perspective view, similar to FIG. 7, showing the expansion plug for the anchor sleeve in the process of being driven into place to expand the sleeve into engagement with the walls of the bore;

FIG. 9 is a perspective view, similar to FIG. 8, showing the anchor sleeve fully expanded and the bolt in the process of being tightened to secure a plate to the surface of the concrete slab;

FIG. 10 is a perspective view, similar to FIG. 9, showing the bolt of the anchor in the process of being removed, with the anchor sleeve remaining in place within the bore.

### DESCRIPTION OF THE PREFERRED EMBODIMENT

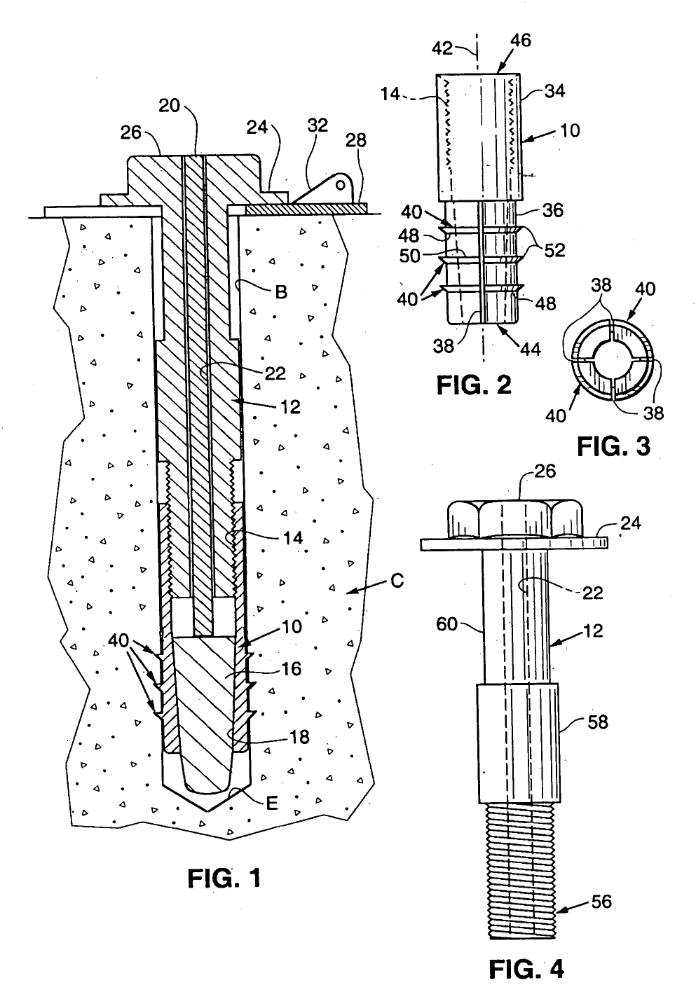

The concrete slab shown in FIG. 1 is depicted by the letter C and shown as having a bore B therein. The bore is formed by drilling and terminates in a frusto-conical end E.

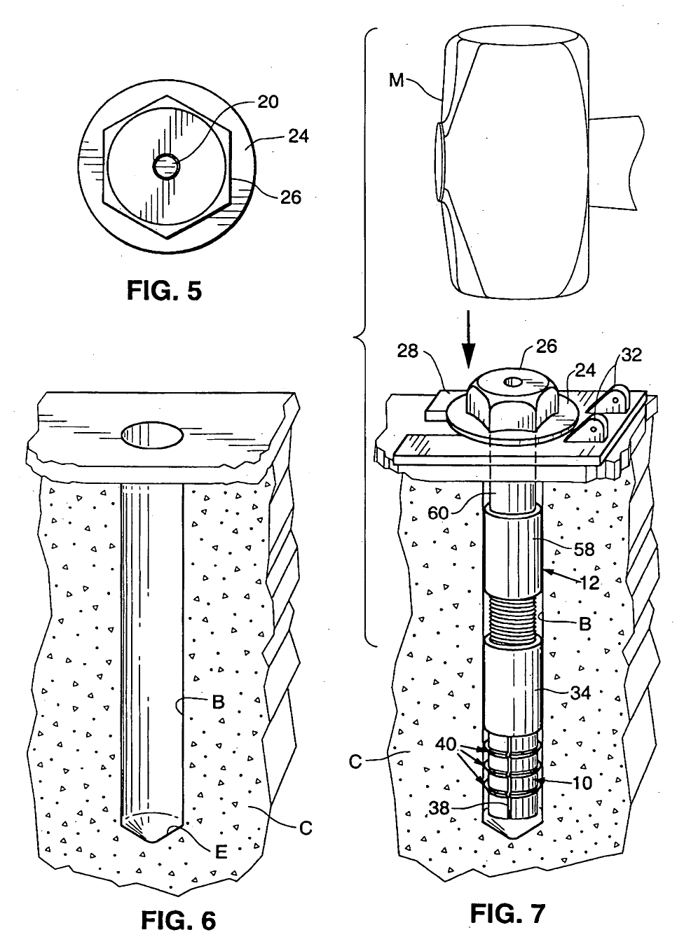

As shown in FIG. 1, the anchor assembly of the present invention is fully in place within the bore B. The assembly comprises: a sleeve 10; a bolt 12 threably engaged in a screw threaded upper portion 14 of the sleeve; a frusto-conical plug 16 received within and extending through a complimental inwardly tapered portion 18 of the sleeve 10; and an activation rod 20 extending slidably through a passage 22 therefor in the bolt 12. The upper end of the bolt has an integrally formed collar 24 and hex-head 26 (see FIGS. 4 and 5).

As shown in FIG. 1, a plate 28 having a slot 30 (see FIG. 7) extending partially thereacross is secured beneath the collar 24. The plate 24 has aligned apertured ears 32 extending upwardly therefrom. These ears may be used to attach any desired component to the plate 26, e.g. a brace for a tilt-up slab.

The sleeve 10 is shown, in detail, in FIGS. 2 and 3. It comprises: a cylindrical section 34; a reduced diameter split section 36 integrally formed with and extending from the cylindrical section, said split section having slots 38 extending longitudinally over its length to divide the section into four quadrants (see FIG. 3); and, arcuate protrusions 40 extending radially from the split sections. The arcuate protrusions 40 provide three longitudinally spaced rings extending around the split section, each of which rings is interrupted by the slots 38.

As shown in FIG. 2, the sleeve 10 has a longitudinal axis 42, a leading end 44 and a trailing end 46. The protrusions 40 are disposed in planes extending normal to the longitudinal axis 42. Each protrusion 40 has leading and trailing surfaces 48 and 50, respectively, which converge to form knife-like edges 52.

The sleeve 10, including the arcuate protrusions 40 extending around the split section 36, has an outside diameter slightly less than that of the bore B, in order that the sleeve may be easily slipped into place within the bore. Placement is also facilitated by sloping the leading surfaces 48 of the protrusions so that they converge toward the leading end of the sleeve.

In a typical embodiment, the sleeve 10 is formed of 4140 steel, with the following dimensions, in millimeters:

overall length: 65.50/64.50

slot length: 32.50/31.00

cylindrical section length: 37.60/38.40

screw threaded portion: 30.00/31.00

outside diameter of cylindrical section: 22.98/22.85

minimum diameter of tapered portion: 13.50/14.00

maximum diameter of tapered portion: 15:80/15.50.

With the above dimensions for the sleeve 10, typical dimensions for the plug 16 would be:

Length: 19.05

minimum diameter: 14.47

maximum diameter: 15.76.

The leading edges of the sleeve 10 and plug 16 are chamfered, externally. The rearward edge of the sleeve 10 is inwardly chamfered.

The bolt 12 is of a unitary construction and, as may be seen from FIG. 4, comprises: a screw threaded distal portion 56 for threaded engagement in the screw threaded portion 14 of the sleeve 10; a collar 58 to improve the bending characteristics of the bolt and assist in maintaining it in alignment with the bore B; and, a reduced diameter section 60 proportioned so that the key slot 30 of the plate 28 may be easily slid around the bolt.

FIG. 7 shows the first step of placing the drop-in anchor. As there shown, the plug 16 is loosely received within the inwardly tapered portion 18 of the sleeve 10 and bolt 12 is threadably received within the screw threaded portion 14 of the sleeve. The assembled anchor is then slid into place within the bore B, with the plate 28 engaged beneath the flange 24 of the bolt. The outside diameter of the anchor assembly is slightly less than that of the bore, in order to assure that the assembly may be easily slid into place within the bore. A mallet M is used to tap the bolt fully into place within the bore.

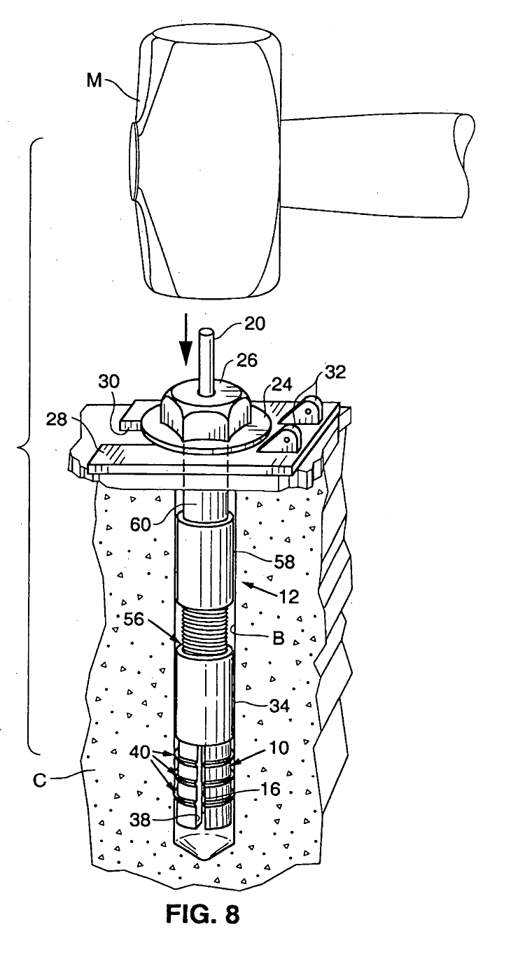

FIG. 8 shows the anchor assembly and place within the bore B, with the sleeve 10 in the process of being expanded into secure gripping engagement with the interior of the bore. As there shown, the rod 20 is slidably extended into the passage 22 and engaged with the top of the plug 16 (see FIG. 1). The mallet M is used to drive the rod 20 downwardly, against the top of the plug 16, thus moving the plug longitudinally and spreading the split section 36 to force the knife-like edges of the protrusions 40 into cutting engagement with the wall of the bore B. (FIG. 1 shows the sleeve fully expanded, with the protrusions so engaged and cut into the walls of the bore.)

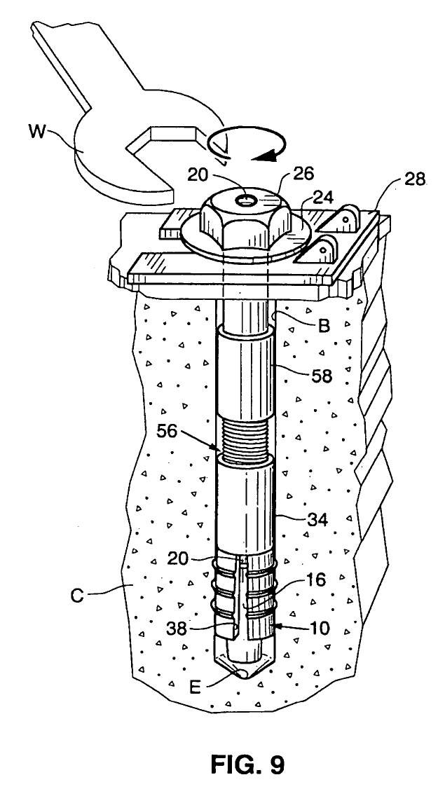

The fully engaged condition of the sleeve 10 may also be seen from FIG. 9. As there shown, the plug 16 extends through the sleeve 10 and partially into the end E of the bore B. FIG. 9 also shows that the rod 20 is so proportioned that when the top of the rod is flush with top of the bolt head 26, the sleeve 10 is fully expanded. The flush interrelationship of the top of the rod and top of the bolt also indicates that the anchor is fully seated.

FIG. 9 also shows a wrench W in the process of tightening the bolt 12. Such tightening securely compresses the plate 28 between the flange 24 and the top surface of the concrete structure C, thus assuring that the plate cannot inadvertently move.

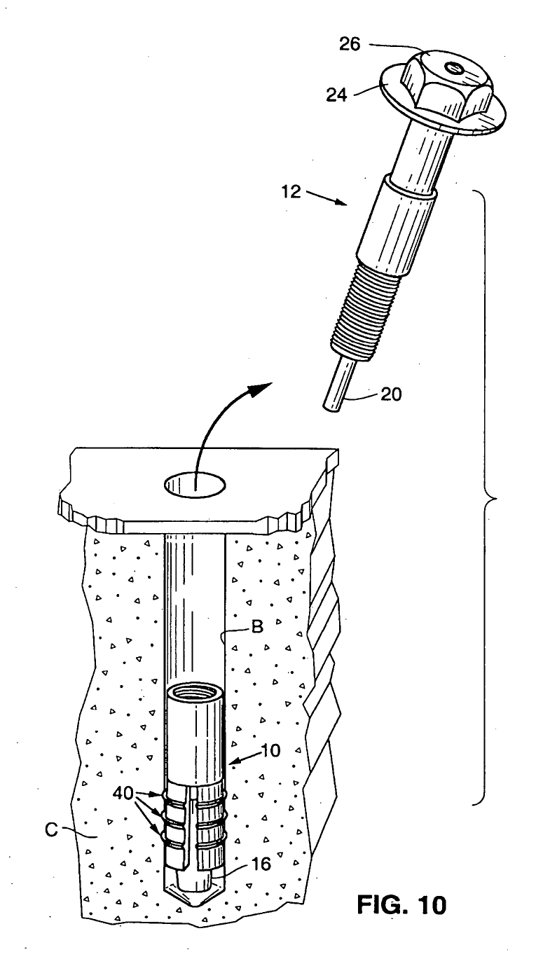

FIG. 10 shows the final step of removing the reusable portions of the anchor assembly (the bolt 12 and rod 20) from the bore B. As there shown, the bolt 12 has been unscrewed from the sleeve 10 and the bolt and rod have been removed from the bore, leaving the sleeve 10 and plug 16 in place. The bore may then be grouted over, if desired.

FIGS. 1 and 10 illustrate both how the protrusions 40 extend into cutting engagement with the walls of the bore and resist pullout of the sleeve, relative to the bore. Such resistance is maximized by locating the protrusions 40 in planes which extend normal to the axis 42 and forming the protrusions so that the trailing surfaces 50 thereof also extend normal to that axis.

### CONCLUSION

From the foregoing description and accompanying drawings, it will be apparent that the present invention provides an improved and more secure drop-in anchor. In particular, it provides an anchor which penetrates and securely engages the walls of a bore within which it received, without the requirement of pre-formed undercuts, or the possibility that relative frictional movement of the anchor sleeve within the bore may fluidize the concrete at the surface of the bore.

1. A drop-in anchor for insertion into a cylindrical bore formed in a concrete structure, said anchor comprising:
a. a sleeve coaxially insertable into the bore, said sleeve being of a diameter slightly less than that of the bore and having an expansible split section;
b. one or more arcuate protrusions formed on and extending at least partially around the split section, said protrusions being proportioned to slide into place within the bore as the sleeve is inserted thereinto and having distally disposed knife-like edges;
c. a tapered surface formed internally of the split section; and
d. a tapered plug received within the split section for movement relative to the sleeve and engagement with the tapered surface to expand the split section and force the knife-like edges into cutting engagement with the bore.

2. A drop-in anchor according to claim 1 wherein the protrusions are integral with the sleeve.

3. A drop-in anchor according to claim 2 wherein:
a. the sleeve is of an elongate configuration having a longitudinal axis and a leading end;
b. at least certain of the protrusions extend in a plan disposed generally normal to the longitudinal axis; and,
c. the protrusions have leading and trailing surfaces which converge to form the knife-like edges.

4. A drop-in anchor according to claim 3 wherein:
a. the leading surfaces of the protrusions slope relative to the longitudinal axis to converge toward the leading end of the sleeve; and,
b. the trailing surfaces of the protrusions extend in plan generally normal to the longitudinal axis.

5. A drop-in anchor according to claim 3, wherein:
a. the sleeve has a trailing end; and
b. the trailing end is formed with screw threads for threaded receipt of a bolt extended into the bore.

6. A drop-in anchor according to claim 3 wherein a plurality of said arcuate protrusions are formed on and extend at least partially around the split section in longitudinally spaced relationship to one another.

7. A drop-in anchor for insertion into a cylindrical bore formed in a concrete structure, said anchor comprising:
a. a sleeve coaxially insertable into the bore, said sleeve being of a diameter slightly less than that of the bore and having a radially expansible section;
b. one or more arcuate protrusions formed on and extending at least partially around the expansible section, said protrusions being proportioned to slide into place within the bore as the sleeve is inserted thereinto and having distally disposed knife-like edges;
c. means to radially expand-the expansible section and force the knife-like edges into cutting engagement with the bore.

8. A drop-in anchor according to claim 7 wherein the protrusions are integral with the sleeve.

9. A drop-in anchor according to claim 8 wherein:
a. the sleeve is of an elongate configuration having a longitudinal axis and a leading end;
b. at least certain of the protrusions extend in a plan disposed generally normal to the longitudinal axis; and,
c. the protrusions have leading and trailing surfaces which converge to form the knife-like edges.

10. A drop-in anchor according to claim 9 wherein:
a. the leading surfaces of the protrusions slope relative to the longitudinal axis to converge toward the leading end of the sleeve; and,
b. the trailing surfaces of the protrusions extend in plan generally normal to the longitudinal axis.

11. A drop-in anchor according to claim 9, wherein:
a. the sleeve has a trailing end; and
b. the trailing end is formed with screw threads for threaded receipt of a bolt extended into the bore.

12. A drop-in anchor according to claim 9 wherein a plurality of said arcuate protrusions are formed on and extend at least partially around the expansible section in longitudinally spaced relationship to one another.

13. A method for providing an anchor within a bore formed in a concrete structure, said method comprising:
a. providing a radially expansible sleeve of a diameter slightly less than that of the bore, said sleeve having one or more arcuate protrusions extending at least partially therearound with knife-like distal edges;
b. inserting the sleeve coaxially into the bore; and,
c. radially expanding the sleeve to force the knife-like edges into cutting engagement with the bore.

14. A method according to claim 12, wherein the protrusions are formed integrally with the sleeve.

15. A method according to claim 14, wherein:
a. the sleeve is of an elongate configuration having a longitudinal axis and a leading end;
b. at least certain of the protrusions are formed to extend in a plan disposed generally normal to the longitudinal axis; and,
c. the protrusions have leading and trailing surfaces which converge to form the knife-like distal edges.

16. A method according to claim 15, wherein:
a. the leading surfaces of the protrusions are formed to slope relative to the longitudinal axis and converge toward the leading end of the sleeve; and,
b. the trailing surfaces of the protrusions are formed to extend in plan generally normal to the longitudinal axis.

17. A method according to claim 15, wherein:
a. the sleeve has a trailing end; and
b. the trailing end is formed with screw threads for threaded receipt of a bolt extended into the bore.

18. A method according to claim 15 wherein a plurality of said arcuate protrusions are formed on the extend at least partially around the expansible section in longitudinally spaced relationship to one another.
